(19) United States
(12) Patent Application Publication
(10) Pub. No.: US 2005/0053139 A1
(43) Pub. Date: Mar. 10, 2005

(54) Method and apparatus for determining reference data unit for predictive video data coding

(75) Inventor: Gwang-hoon Park, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/929,525

(22) Filed: Aug. 31, 2004

(30) Foreign Application Priority Data
Sep. 4, 2003 (KR) 2003-61630

(51) Int. Cl. H04N 7/12

(52) U.S. Cl. 375/240.16; 375/240.12

(57) ABSTRACT

A method and apparatus for determining a reference data unit for predictive video data coding. The method includes: selecting at least one previous data unit located adjacent to a current data unit from among previous data units; and determining at least one reference data unit for predictive coding or decoding the current data unit from among the selected previous data units.

### CROSS-REFERENCE TO RELATED APPLICATION

This application claims the benefit of Korean Patent Application No. 2003-61630, filed on Sep. 4, 2003, in the Korean Intellectual Property Office, the disclosure of which is incorporated herein in its entirety by reference.

### BACKGROUND OF THE INVENTION

1. Field of the Invention

The invention relates to predictive video data coding, and more particularly, to a method and apparatus for determining a reference data unit for predictive coding a current data unit.

2. Description of the Related Art

Compression coding is required to store or transmit a mass of video data of a still or moving picture. Video data coding and/or decoding is performed on each predetermined data unit of a macroblock, block, or pixel. In order to perform video data coding and/or decoding on each predetermined data unit, a process of scanning data units of a picture is performed.

FIG. 1 is a diagram illustrating a conventional raster-scan method. Referring to FIG. 1, in the conventional raster-scan method, data units of a picture are scanned from left to right and from top to bottom. In other words, a data unit at the left upper corner of the picture is the first data unit scanned.

A new video data scan method has recently been developed. Korean Patent Publication No. 2002-5365, entitled “Water Ring Scan Apparatus and Method and Video Data Coding and/or Decoding Apparatus and Method Using the Same,” discloses a water ring scan method. FIG. 2 is a diagram illustrating a conventional water ring scan method. Referring to FIG. 2, a picture includes a plurality of data units. In the water ring scan method, scanning starts from a predetermined position on the picture, for example, a central data unit of the picture, and gradually progresses to outer data units of the picture in a clockwise or counterclockwise direction. When the data units of the picture are scanned using the water ring scan method, a plurality of water rings surround the central data unit from which scanning starts.

As shown in FIG. 2, the central data unit from which the water ring scan method starts is represented as “0” and is surrounded by a plurality of water rings. Data units of a first water ring 11 are represented by “1”, data units of a second water ring 13 are represented by “2”, and data units of third, fourth, and fifth water rings 15, 17, 19 are represented by “3”, “4”, and “5”, respectively. Each of the first, second, third, fourth, and fifth water rings 11, 13, 15, 17, and 19 is a square-shaped ring.

Meanwhile, a new video coding standard called MPEG-4 Part 10 advanced video coding (AVC) or ITU-T H.264 has been established. In particular, with the rapid spread of new communication channels such as a mobile communication network, AVC/H.264 has been developed to cope with a change from an existing circuit-switched way to packet-switched service and various types of communication infrastructures.

AVC/H.264 is a video coding standard that increases coding efficiency by more than 50% compared to MPEG-4 Part 2 Visual Codec and adopts a coding method that is robust to errors and familiar to a network in order to deal with advances in wireless and Internet environments/technologies.

In particular, in order to actively meet a transmission error in an environment in which each packet is transmitted, such as a wireless transmission environment or the Internet environment, MPEG-4 Part 10 AVC adopts a new video data scan method that is called flexible macroblock ordering (FMO). In detail, FMO includes seven types of modes, the third one of which is named a box-out scan method. The box-out scan method is a type of the above-described water ring scan method. In the box-out scan method, a picture is divided into a user-interested region and a background region, which are coded and decoded using different methods.

FIG. 3 is a diagram showing a picture, which is divided, into a region of interest (ROI) 21 and a leftover region 23. A main ROI of a picture is generally located in the center of the picture. Thus, according to the center of the picture, a region within a predetermined range is defined as the ROI 21 and the rest of the picture is defined as the leftover region 23. In order to code and decode the ROI 21 independent of the leftover region 23, the leftover region 23 is not used when spatial predictive coding is performed on the ROI 21.

FIG. 4A is a diagram showing a box-out scan method of scanning data units in a clockwise direction, and FIG. 4B is a diagram showing a box-out scan method of scanning data units in a counterclockwise direction. The box-out scan method is a method of coding an ROI and enables coding efficiency and/or protects video data from errors in consideration of human's visual characteristics. In particular, since the ROI can be error-protected better than a leftover region during coding and the ROI can be coded independent of the leftover region, data in the leftover region can be coded at a low bit rate and low calculation complexity. In particular, during a gradual random access, a decoder restructures only the ROI and an encoder transmits only data in the ROI to the decoder.

However, intra-block-based coding is performed on video data, which is scanned using an AVC/H.264 box-out scan method, without using motion estimation and/or motion compensation. Therefore, not using predictive coding to remove the overlap of video data on temporal and spatial axes deteriorates coding efficiency. Further, conventional predictive coding is based on the raster-scan method and thus cannot be performed on video data that is scanned using the box-out scan method.

FIG. 5 is a diagram showing reference macroblocks for calculating a motion vector predicted value of a current macroblock, according to conventional technology. As an example of predictive coding, motion vectors of neighboring macroblocks, which have been already scanned and coded, are used to code a motion vector of a current macroblock. Referring to FIG. 5, macroblocks B1, B2, B3, B4, B5, and B6 are sequentially scanned using a raster-scan method and then coded. When the macroblock B6 is a current macroblock, a motion vector predicted value of the current macroblock B6 is calculated using motion vectors of the macroblocks B1, B2, B3, and B5 that have been scanned and coded prior to the current macroblock B6.

For example, a median or mean value of motion vectors of all or some of the macroblocks B1, B2, B3, and B5 may be used as the motion vector predicted value of the current macroblock B6. After the motion vector predicted value of the current macroblock B6 is calculated, an encoder calculates a motion vector difference (MVD) between a substantial motion vector value and the motion vector predicted value of the current macroblock 6, performs variable length coding (VLC) on the MVD, and transmits the coded MVD to a decoder.

However, a motion vector predicted value of a current macroblock cannot be calculated using macroblocks, that are scanned using the box-out scan method shown in FIG. 4A or 4B, adopting the above-described predictive coding method.

FIG. 6 is a diagram showing reference data units selected to calculate a motion vector predicted value of a current data unit from among data units which are scanned using the clockwise box-out scan method of FIG. 4A. Data units C2, C3, C10, and C11 are used to calculate a motion vector predicted value of a current data unit C1 adopting the predictive coding method described with reference to FIG. 5. However, when the clockwise box-out scan method is used, the data units C2, C3, C10, and C11 are to be scanned and coded after the current data unit C1 and thus cannot be used to calculate the motion vector predicted value of the current data unit C1.

Similar to the above-described water ring scan method or the box-out scan method, a region of interest oriented scan method scans data units starting from the center of a picture and moving outward toward the outer edges of the picture. Therefore, predictive coding based on the conventional raster-scan method cannot be performed on video data which is scanned using the region of interest oriented scan method.

### SUMMARY OF THE INVENTION

The invention provides a method and apparatus for determining reference data units for predictive coding or decoding video data, which are scanned using a region of interest oriented scan method, to allow temporal or spatial coding or decoding to be performed on the video data in order to improve coding efficiency for the video data.

According to an aspect of the invention, there is provided a method of determining at least one reference data unit for predictive coding or decoding a current data unit, from among at least one previous data unit that is scanned prior to the current data unit using a region of interest oriented scan method by which a data unit in a predetermined location of the region of interest is first scanned and then outer data units are sequentially scanned. The method includes: selecting at least one previous data unit adjacent to the current data unit from among the at least one previous data unit; and determining the at least one reference data unit for predictive coding or decoding the current data unit from among the selected at least one previous data unit.

According to another aspect of the invention, there is provided a method of determining a reference data unit for predictive coding or decoding a current data unit from among a plurality of previous data units which are scanned prior to the current data unit using a region of interest oriented scan method by which a data unit in a predetermined location of a region of interest is first scanned so that remaining data units in the region of interest form themselves into a plurality of square rings that surround the data unit in the predetermined location. The method includes: selecting a previous data unit, which is scanned right before the current data unit, from among at least one previous data unit belonging to a current square ring including the current data unit; selecting at least one previous data unit adjacent to the current data unit from among the at least one previous data unit belonging to a previous square ring that is surrounded by the current square ring; and determining at least one reference data unit for predictive coding or decoding the current data unit from among the selected at least one previous data unit.

According to another aspect of the invention, there is provided an apparatus for determining a reference data unit for predictive coding or decoding a current data unit. The apparatus includes: a previous data unit selector which selects at least one previous data unit adjacent to the current data unit from among at least one previous data unit that is scanned prior to the current data unit using a region of interest oriented scan method by which a data unit in a predetermined location of the region of interest is first scanned, and then remaining data units are sequentially scanned; and a reference data unit determiner that determines at least one reference data unit for predictive coding or decoding the current data unit, from among the selected at least one previous data units.

According to another aspect of the invention, there is provided an apparatus for determining a reference data unit for predictive coding or decoding a current data unit. The apparatus includes: a previous data unit selector that selects at least one previous data unit, which is scanned and coded in a location before the current data unit, from among a plurality of previous data units that are scanned prior to the current data unit using a region of interest oriented scan method by which a data unit in a predetermined location of a region of interest is first scanned so that remaining data units in the region of interest form themselves into a plurality of square rings that surround the data unit in the predetermined location and then selects at least one previous data unit adjacent to the current data unit, from among the at least one previous data unit belonging to a previous square ring that is surrounded by a current square ring; and a reference data unit determiner that determines at least one reference data unit for predictive coding or decoding the current data unit, from among the at least one selected previous data units.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram showing a conventional raster-scan method;

FIG. 2 is a diagram showing a conventional water ring scan method;

FIG. 3 is a diagram showing a picture which is divided into an ROI and a leftover region, according to a conventional method;

FIG. 4A is a diagram showing a conventional clockwise box-out scan method;

FIG. 4B is a diagram showing a conventional counterclockwise box-out scan method;

FIG. 5 is a diagram showing reference macroblocks for calculating a motion vector predicted value of a current macroblock, according to a conventional method;

FIG. 6 is a diagram showing reference data units selected to calculate a motion vector predicted value of a current data unit from among data units that are scanned using the conventional clockwise box-out scan method;

FIG. 7 is a diagram showing reference data units that are to be determined in order to predictive code and/or decode data units that are scanned using a region of interest scan method, according to and aspect of the invention.

FIG. 8 is a block diagram of an apparatus for determining reference data units for predictive coding or decoding, according to an aspect of the invention;

FIG. 9 is a flowchart illustrating a method of determining reference data units, according to an aspect of the invention;

FIG. 10 is a diagram showing previous data units for predictive coding data units that are scanned using a clockwise box-out scan method, according to an aspect of the invention;

FIG. 11 is a diagram showing a region of interested oriented scan method of scanning data units in a diagonal direction, according to an aspect of the invention; and

FIG. 12 is a flowchart illustrating a method of determining reference data units, according to another aspect of the invention.

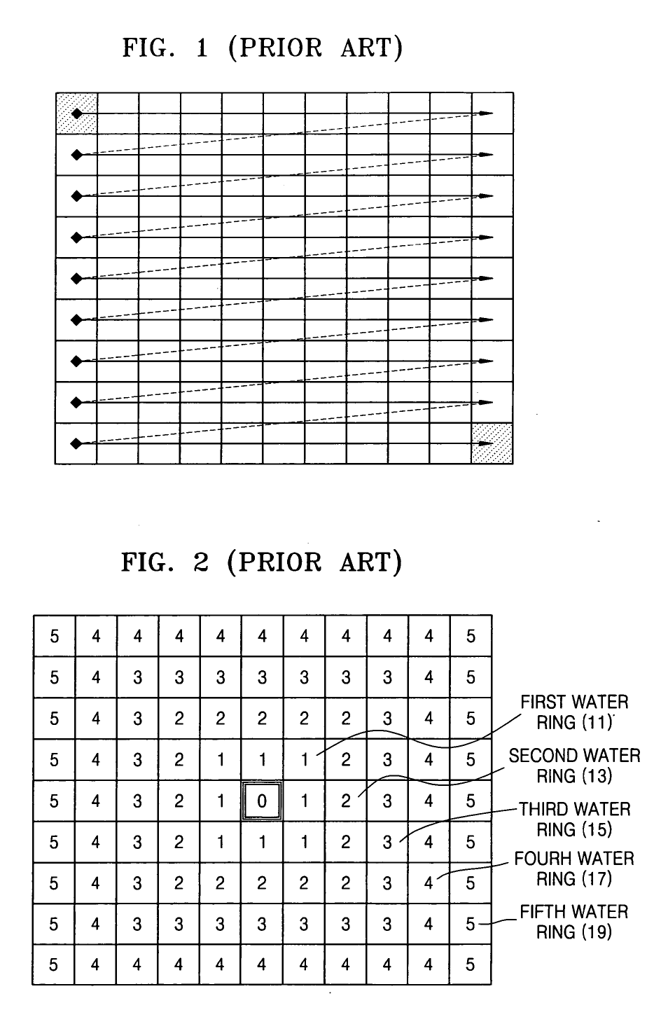

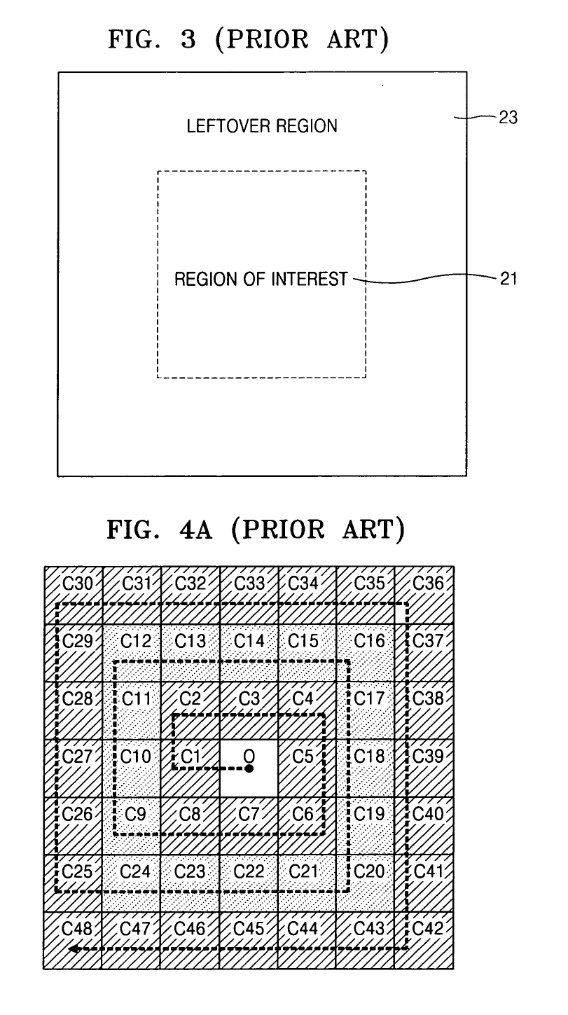

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The invention relates to a method of scanning data units from the center of a picture toward the outer edges of the picture, similar to the conventional water ring scan method or box-out scan method, as a region of interest oriented scan method. Here, a data unit refers to a macroblock, a block, a pixel, a predetermined number of pixels, or the like on which predetermined predictive coding and/or decoding is to be performed.

Predictive coding is a technique that uses the coding results of neighboring data units to code a current data unit. Examples of predictive coding include: predicting a motion vector value of a current data unit using motion vector values of neighboring data units; predicting a discrete cosine transform (DCT) coefficient value of a current block using DCT coefficient values of neighboring blocks; predicting a value of a current pixel using values of neighboring pixels; and so forth. Predictive decoding essentially undergoes a process that is reverse to that of predictive coding.

At least one reference data unit must be determined to predictively code and/or decode a current data unit. An aspect of the invention provides an apparatus and method of determining reference data units for predictive coding or decoding a current data unit from among data units that are scanned using the region of interest oriented scan method.

FIG. 7 is a diagram illustrating reference data units that are determined in order to predictive code and/or decode data units that are scanned using a region of interest scan method, according to an aspect of the invention. Referring to FIG. 7, reference data units are determined for data units E1 through E14. The data unit E1 is secondly scanned in an ROI, the data units E2 through E5 are located at the corners of a square ring, the data units E6 through E13 are vertically or horizontally adjacent to the reference data units E2 through E5, respectively, and the data unit E14 is first scanned from among a plurality of data units belonging to a special square ring. Since there is no reference data unit for a data unit O, which is first scanned in the ROI, the data unit O is not predictive coded but rather intra-coded.

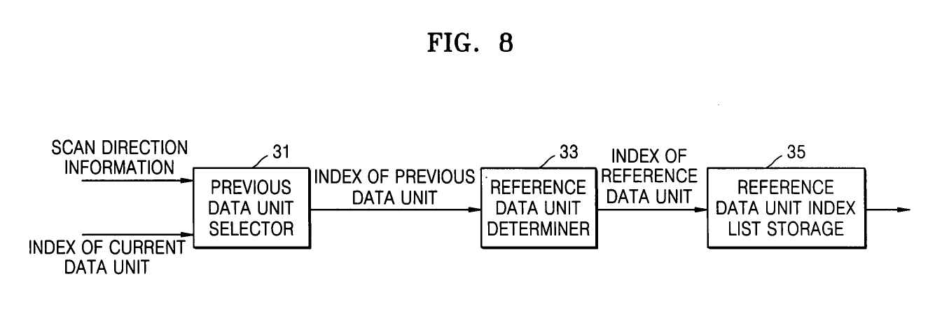

FIG. 8 is a block diagram of an apparatus for determining reference data units for predictive coding and/or decoding, according to an aspect of the invention. Referring to FIG. 8, the apparatus includes a previous data unit selector 31, a reference data unit determiner 33, and a reference data unit index list storage 35.

The previous data unit selector 31 selects one of previous data units, which have been scanned prior to a current data unit (not shown), as a reference data unit with reference to input scan direction information and an index of the current data unit. The previous data unit selector 31 may further receive an index of a data unit, that has been first scanned in a picture including the current data unit, or may pre-store an index of a data unit that has been first scanned. Here, a previous data unit refers to a data unit that is to be scanned and predictive coded ahead of a current data unit to be predictive coded.

The reference data unit determiner 33 receives an index of the selected previous data unit from the previous data unit selector 31 to determine a reference data unit using a predetermined method.

The reference data unit index list storage 35 receives an index of the determined reference data unit from the reference data unit determiner 33 and stores the index of the determined reference data unit. The stored index of the reference data unit is used to predictive code the current data unit.

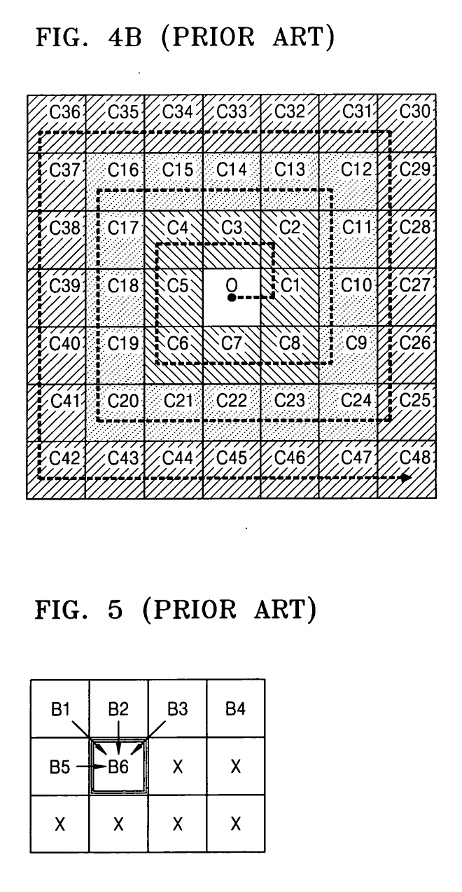

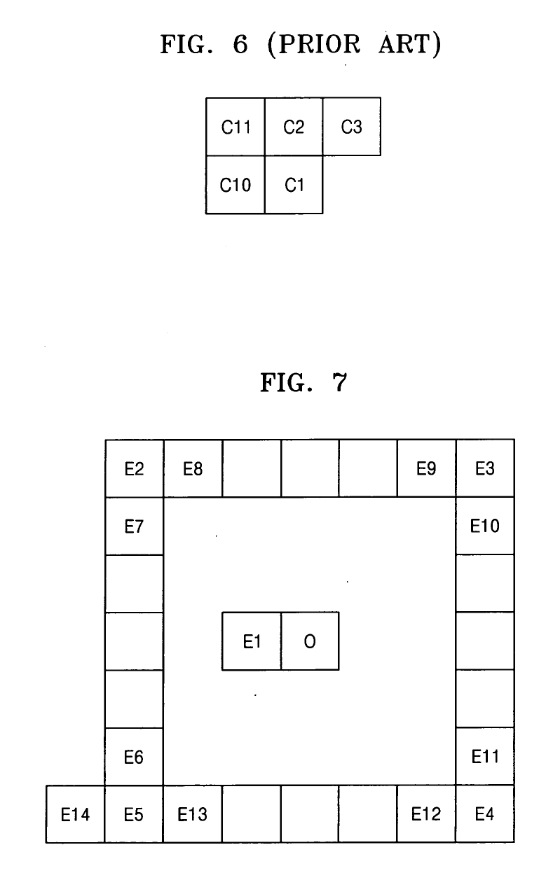

An example of a method of determining a reference data unit by scanning data units using the apparatus of FIG. 8 and the clockwise box-out scan method of FIG. 4A will now be described.

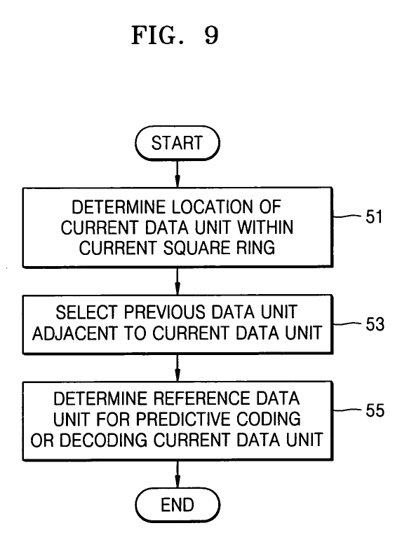

FIG. 9 is a flowchart for explaining a method of determining a reference data unit, according to an aspect of the invention.

Referring to FIG. 9, in operation 51, the previous data unit selector 31 determines the location of a current data unit within a current square ring according to an index and scan direction of the current data unit. For example, as shown in FIG. 7, the previous data unit selector 31 determines whether the current data unit is located at a corner of the current square ring including the current data unit, vertically or horizontally adjacent to a data unit at a corner of the current square ring, or is one of a plurality of data units that is first scanned in a special square ring. The previous data unit selector 31 may also determine whether the current data unit corresponds to the data unit E1, that is secondly scanned in the ROI as shown in FIG. 7.

In operation 53, the previous data unit selector 31 selects previous data units that are useable for predictive coding the current data unit and are adjacent to the current data unit, with reference to the location of the current data unit within the current square ring. In operation 55, the previous data unit selector 31 then determines a reference data unit for predictive coding and/or decoding the current data unit.

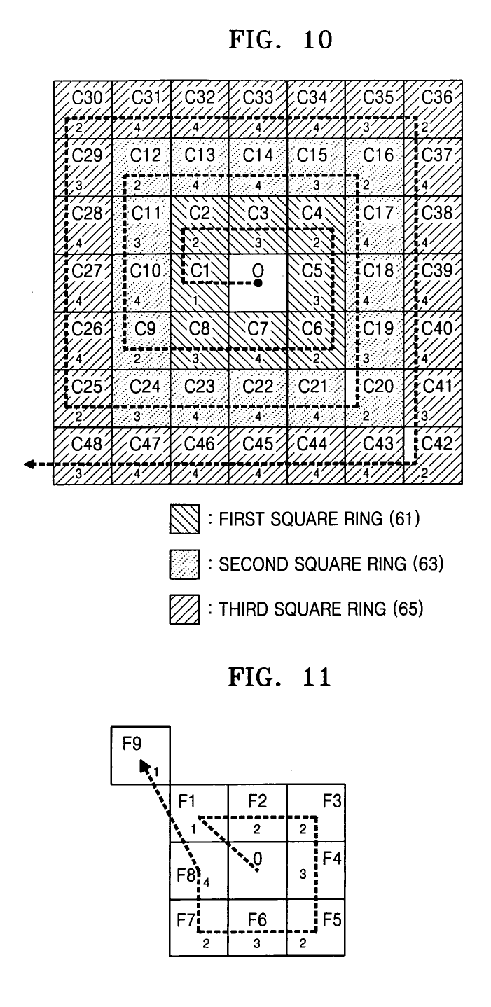

FIG. 10 is a diagram showing previous data units for predictive coding data units that are scanned using a clockwise box-out scan method. An ROI of a picture to be currently coded is shown in FIG. 10. A data unit O is located in the center of the ROI. When the region of interest oriented scan method according to an aspect of the invention shown in FIG. 10 is used, the data unit O is first scanned, and then data units C1, C2, . . . , and C48 are sequentially scanned in a clockwise direction.

Referring to FIG. 10, a first square ring 61 includes the data units C1 through C8, a second square ring 63 includes the data units C9 through C24, and a third square ring 65 includes the data units C25 through C48. The first, second, and third square rings 61, 63, and 65 enclose the data unit O in the center of the picture. The scanning is not limited to three square rings and may include additional or fewer square rings.

The number of adjacent previous data units used as reference data units for predictive coding each of the data units C1, C2, . . . , and C48 is written in each of the data units C1, C2, . . . , and C48. In view of the locations of the data units O, C1, C2, . . . , and C48, only the data unit O is adjacent to the data unit C1 to be scanned after the data unit O. Thus, the number of previous data units adjacent to the data unit C1 is one.

Previous data units adjacent to data units at the corners of a square ring will now be explained. For example, previous data units, which are adjacent to the data unit C2 at the left top corner of the first square ring 61, are the data units O and C1. Previous data units, which are adjacent to the data unit C4 at the right top corner of the first square ring 61, are the data units O and C3. Previous data units, which are adjacent to the data unit C6 at the right bottom corner of the first square ring 61, are the data units O and C5. Three previous data units, i.e., the data units O, C1, and C7, are exceptionally adjacent to the data unit C8 at the left bottom corner of the first square ring 61.

Next, previous data units, which are vertically, horizontally, and diagonally adjacent to data units at the corners of a square ring, will be described. For example, in a case of the data unit C11 of the second square ring 63, three previous data units, i.e., the data units C1, C2, and C10, are adjacent to the data unit C11. Four previous data units, i.e., the data units C2, C3, and C11, and C12, are adjacent to the data unit C13. Three or four previous data units are adjacent to each of the data units C15, C17, C19, C21, and C23.

However, the data unit C9 corresponds to a special case. Only two previous data units, i.e., the data units C1 and C8, are adjacent to the data unit C9 because the data unit C9 is first scanned in the second square ring 63 after the data units C1 through C8 of the first square ring 61 are scanned.

Four previous data units are located adjacent to the data units that are provided in locations other than the above-described data unit locations.

With reference to FIG. 10, it has been described that the data unit O is first scanned, and then the data units C1, C2, C3, . . . , and C48 are sequentially scanned. However, the scanning order is not limited to the case described in FIG. 10. In other words, scanning may be performed on the data unit C3 after the data unit O and then continue in a clockwise direction, may be performed on the data unit C5 after the data unit O and then continue in a clockwise direction, or may be performed on the data unit C7 after the data unit O and then continue a clockwise direction. In each of the cases, previous data units for predictive coding each data unit is determined using the above-described method.

FIG. 10 describes a case where data units are scanned using the clockwise box-out scan method. However, even when data units are scanned using the counterclockwise box-out scan method of FIG. 4B, previous data units for predictive coding each of the data units may be determined using the above-described method.

FIG. 11 is a diagram showing a case of diagonally scanning data units after a data unit in the center of a picture. As shown in FIG. 11, a data unit not vertically or horizontally but rather diagonally adjacent to a data unit O is scanned after the data unit O. Thus, the selection of a previous data unit for predictive coding a current data unit corresponds to a special case. A figure written in each of data units F1 through F9 as shown in FIG. 11 denotes the number of previous data units which are adjacent to each of the data units F1 through F9 to be used for predictive coding each of the data units F1 through F9. For example, F1 and F9 each have one previous adjacent unit; F2, F3, F5, and F7 each have two previous adjacent units; F4 and F6 each have three previous adjacent units; and F8 has four previous adjacent units.

Since the data unit F1 is located at a corner and scanned after the data unit O, only one previous data unit, i.e., the data unit O, is adjacent to the data unit F1, and only one previous data unit, i.e., the data unit F1, is adjacent to the data unit F9.

Referring to FIG. 9, when the previous data unit selector 31 selects the previous data units for predictive coding the current data unit in operation 53, in operation 55, the reference data unit determiner 33 receives indexes of the previous data units used as reference data units from the previous data unit selector 31 and determines reference data units for predictive coding and/or decoding the current data unit from among the previous data units using a predetermined method. Here, a reference data unit refers to a previous data unit that is selected from among previous data units adjacent to the current data unit to be substantially used for predictive coding a current data unit.

The reference data unit to be substantially used for predictive coding the current data unit is determined according to features, coding performance, and efficiency of corresponding predictive coding using various methods. For example, when a motion vector of a current data unit is predictive coded, all or some of the previous data units selected in operation 53 are determined as reference data units, and a median or mean value of motion vectors of the reference data units is determined as a motion vector predicted value of the current data unit.

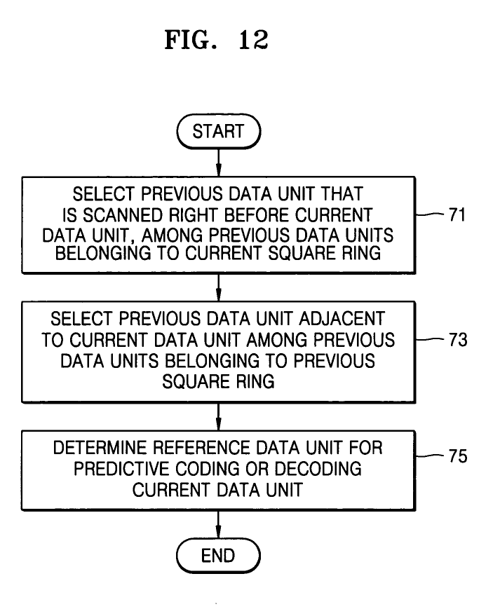

FIG. 12 is a flowchart for explaining a method of determining reference data units, according to another aspect of the invention. The method of FIG. 12 may be performed using the apparatus of FIG. 8 and the clockwise box-out scan method of FIG. 4A. In operation 71, the previous data unit selector 31 selects a previous data unit, that is scanned right before a current data unit, from among previous data units belonging to a current square ring including the current data unit. For example, describing the case of FIG. 10, a current square ring including the current data unit C10 is a second square ring including data units C9 through C24, where the data unit C9 is scanned right before the current data unit C10.

In operation 73, the previous data unit selector 31 selects at least one previous data unit adjacent to the current data unit, from among previous data units belonging to a previous square ring surrounded by the current square ring. For example, as shown in FIG. 4A, the previous square ring, which is surrounded by the second square ring including the current data unit C10, is a first square ring including data units C1 through C8, where the data units C1, C2, and C8 are adjacent to the current data unit C10.

The results of operations 71 and 73 of FIG. 12 are identical to those of operation 53 of FIG. 9. Thus, the number and locations of previous data units used as reference data units for predictive coding a current data unit are the same as described with reference to FIG. 10.

In operation 75, the reference data unit determiner 33 receives indexes of the selected previous data units from the previous data unit selector 31 and determines reference data units for predictive coding and/or decoding the current data unit from among the selected previous data units using a predetermined method. Here, a reference data unit to be substantially used for predictive coding and/or decoding a current data unit is determined using various methods in consideration of features, performance, and efficiency of corresponding predictive coding.

As described above, the invention relates to a method and apparatus for determining a reference data unit for predictive coding and/or decoding video data, that is scanned using a region of interest oriented scan method, such that the reference data unit is quickly and accurately determined. This enables temporal or spatial predictive coding and/or decoding in order to improve coding efficiency for the video data.

The invention can also be embodied as computer readable codes on a computer readable recording medium. The computer readable recording medium is any data storage device that can store data that can be thereafter read by a computer system. Examples of the computer readable recording media include read-only memory (ROM), random-access memory (RAM), CD-ROMs, magnetic tapes, floppy disks, optical data storage devices, and carrier waves (such as data transmission through the Internet). The computer readable recording medium can also be distributed over network-coupled computer systems so that the computer readable code is stored and executed in a distributed fashion.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of determining at least one reference data unit for predictive coding or decoding a current data unit from among at least one previous data unit that is scanned prior to the current data unit using a region of interest oriented scan method by which a data unit in a predetermined location of a region of interest is first scanned and outer data units are subsequentially sequentially scanned, the method comprising:
selecting at least one previous data unit located adjacent to the current data unit from among the at least one scanned previous data unit; and
determining the at least one reference data unit for predictive coding or decoding the current data unit from among the at least one selected previous data units.

2. The method as claimed in claim 1, wherein the region of interest oriented scan method comprises:
scanning the data unit in the predetermined location such that remaining data units in the region of interest form into a plurality of square rings that enclose the data unit in the predetermined location.

3. The method as claimed in claim 2, wherein the selection of the at least one previous data unit located adjacent to the current data unit comprises:
determining the location of the current data unit within a current square ring having the current data unit; and
selecting the at least one previous data unit adjacent to the current data unit from among the at least one scanned previous data unit with reference to the location of the current data unit.

4. The method as claimed in claim 3, further comprising:
selecting at least two previous data units from among the at least one scanned previous data unit located vertically or horizontally adjacent to the current data unit and one previous data unit located diagonally adjacent to the current data unit when the current data is located at a corner location of the current square ring.

5. The method as claimed in claim 3, further comprising:
selecting is at least three previous data units from the at least one scanned previous data unit located horizontally, vertically, and diagonally adjacent to the current data unit, respectively, when the current data unit is located vertically or horizontally adjacent to a data unit located at a corner of the current square ring.

6. The method as claimed in claim 3, further comprising:
selecting four previous data units when the current data unit is not located at a corner of the current square ring or is not located vertically or horizontally adjacent to a data unit at a corner of the current square ring, such that one data unit is located horizontally adjacent to the current data unit, another data unit is located vertically adjacent to the current data unit, and the remaining two data units are located diagonally adjacent to the current data unit.

7. The method as claimed in claim 2, further comprising:
selecting the data unit in the predetermined location as the previous data unit when the current data unit is scanned immediately after the data unit in the predetermined location.

8. The method as claimed in claim 2, further comprising:
selecting two previous data units located adjacent to the current data unit from the plurality of previous data units belonging to the previous square ring when the current data unit is first scanned from among a plurality of data units belonging to a current square ring and is located adjacent to the current data unit from among the plurality of previous data units belonging to the previous square ring horizontally or vertically adjacent to a data unit that is lastly scanned from among a plurality of previous data units belonging to a previous square ring.

9. The method as claimed in claim 1, wherein the region of interest oriented scan method starts scanning from a data unit located in the center of the region of interest.

10. The method as claimed in claim 1, wherein the selected previous data units are located horizontally, vertically, or diagonally adjacent to the current data unit.

11. The method as claimed in claim 1, wherein the data units are data units on which predictive coding or decoding is performed.

12. A method of determining a reference data unit for predictive coding or decoding a current data unit from among a plurality of previous data units that are scanned prior to the current data unit using a region of interest oriented scan method by which a data unit in a predetermined location of a region of interest is first scanned such that remaining data units in the region of interest form into a plurality of square rings that surround the data unit in the predetermined location, the method comprising:
selecting a previous data unit, which is scanned immediately before the current data unit, from among previous data units belonging to a current square ring having the current data unit;
selecting at least one previous data unit located adjacent to the current data unit from among previous data units belonging to a previous square ring that is surrounded by the current square ring; and
determining at least one reference data unit for predictive coding or decoding the current data unit from among the selected previous data units.

13. The method as claimed in claim 12, further comprising:
selecting the at least one previous data unit located adjacent to the current data unit from among the previous data units belonging to the previous square ring based on the location of the current data unit within the current square ring.

14. The method as claimed in claim 13, further comprising:
selecting the at least one previous data unit located adjacent to the current data unit from among the previous data units belonging to the previous square ring according to whether the current data unit is located at a corner of the current square ring, vertically or horizontally adjacent to a data unit at the corner of the current square ring, or in a remaining location of the current square ring.

15. The method as claimed in claim 14, further comprising:
selecting the at least one previous data unit located adjacent to the current data unit is from among the previous data units belonging to the previous square ring when the current data unit is located at the corner of the current square ring.

16. The method as claimed in claim 14, further comprising:
selecting at least two previous data units located adjacent to the current data unit from among the previous data units belonging to the previous square ring when the current data unit is located vertically or horizontally adjacent to a data unit located at the corner of the current square ring.

17. The method as claimed in claim 14, further comprising:
selecting three previous data units located adjacent to the current data unit from the previous data units belonging to the previous square ring when the current data unit is not located at the corner of the current square ring and is not vertically or horizontally adjacent to a data unit at the corner of the current square ring.

18. The method as claimed in claim 12, wherein the region of interest oriented scan method starts scanning from a data unit located in the center of the region of interest.

19 The method as claimed in claim 12, wherein the at least one previous data unit is located horizontally, vertically, or diagonally adjacent to the current data unit.

20. The method as claimed in claim 12, wherein the data units are data units on which predictive coding or decoding is performed.

21. An apparatus for determining a reference data unit for predictive coding or decoding a current data unit, the apparatus comprising:
a previous data unit selector that selects at least one previous data unit located adjacent to the current data unit from among at least one previous data unit that is scanned prior to the current data unit using a region of interest oriented scan method by which a data unit in a predetermined location of a region of interest is first scanned, and then remaining data units are sequentially scanned; and
a reference data unit determiner that determines at least one reference data unit for predictive coding or decoding the current data unit from among the selected at least one previous data unit.

22. The apparatus as claimed in claim 21, wherein in the region of interest oriented scan method, scanning is performed on the data unit in the predetermined location such that the remaining data units in the region of interest form into a plurality of square rings that enclose the data unit in the predetermined location.

23. The apparatus as claimed in claim 22, wherein the previous data unit selector selects the at least one previous data unit adjacent to the current data unit from among the at least one previous data unit according to the location of the current data unit within a current square ring having the current data unit.

24. The apparatus as claimed in claim 21, wherein the region of interest oriented scan method starts scanning from a data unit located in the center of the region of interest.

25. The apparatus as claimed in claim 21, wherein the at least one previous data unit is located horizontally, vertically, or diagonally adjacent to the current data unit.

26. The apparatus as claimed in claim 21, wherein the data units are data units on which predictive coding or decoding is performed.

27. An apparatus for determining a reference data unit for predictive coding or decoding a current data unit, the apparatus comprising:
a previous data unit selector that selects at least one previous data unit, which is scanned and coded immediately before the current data unit, from among a plurality of previous data units, which are scanned before the current data unit using a region of interest oriented scan method by which a data unit in a predetermined location of a region of interest is first scanned such that remaining data units in the region of interest form into a plurality of square rings that surround the data unit in the predetermined location, and selects at least one previous data unit located adjacent to the current data unit from among previous data units belonging to a previous square ring that is surrounded by a current square ring; and
a reference data unit determiner that determines at least one reference data unit for predictive coding or decoding the current data unit from among the selected at least one previous data unit.

28. The apparatus as claimed in claim 27, wherein the previous data unit selector selects the at least one previous data unit adjacent to the current data unit from among the previous data units belonging to the previous square ring according to the location of the current data unit within the current square ring.

29. The apparatus as claimed in claim 28, wherein the previous data unit selector selects the at least one previous data unit located adjacent to the current data unit from among the previous data units belonging to the previous square ring according to whether the current data unit is located at a corner of the current square ring, is vertically or horizontally adjacent to a data unit at a corner of the current square ring, or is located in one of the remaining locations of the current square ring.

30. The apparatus as claimed in claim 27, wherein the region of interest oriented scan method starts scanning from a data unit located in the center of the region of interest.

31. The apparatus as claimed in claim 27, wherein the at least one previous data unit is located horizontally, vertically, or diagonally adjacent to the current data unit.

32. The apparatus as claimed in claim 27, wherein the data units are data units on which predictive coding or decoding is performed.

33. A computer-readable recording medium to be ready by at least one computer on which a program is recorded to execute the method as claimed in claim 1, in a computer.

34. A computer-readable recording medium to be read by at least one computer on which a program is recorded to execute the method as claimed in claim 12, in a computer.

35. A method of determining at least one reference data unit for predictive coding a current data unit from a plurality of data units scanned prior to the current data unit using a region of interest oriented scanning method that forms at least one ring of data units around the current data unit, comprising:
selecting at least one of the previous data units located adjacent and scanned prior to the current data unit;
determining at least one reference data unit from the at least one selected previously scanned data unit according to predictive coding features; and
predictive coding the current data unit according to the determined at least one reference data unit using a predetermined method.

36. The method of determining at least one reference data unit as claimed in claim 35, wherein the adjacent location of each of the at least one selected previously scanned data unit is located horizontal, vertical, or diagonal to the current data unit.

37. The method of determining at least one reference data unit as claimed in claim 35, further comprising:
predictive coding the current data unit based on a motion vector predicted value of the current data unit determined by performing a statistical analysis of respective motion vector values for at least two of the previously scanned data units located adjacent to the current data unit.

38. The method of determining at least one reference data unit as claimed in claim 35, wherein the region of interest oriented scanning method comprises:
scanning the data units surrounding the current data unit in a rotational direction such that the region of interest includes a plurality of connected concentric rings extending towards the perimeter of the region of interest and enclosing the current data unit.

39. The method of determining at least one reference data unit as claimed in claim 38, wherein when the current data unit is a connecting data unit that connects a current concentric ring with a previous concentric ring, predictive coding is performed according to two previous data units located adjacent and scanned prior to current data unit

40. The method of determining at least one reference data unit as claimed in claim 38, further comprising scanning the previous data units used for predictive coding using in a rotational direction about a predetermined data unit.

41. The method of determining at least one reference data unit as claimed in claim 40, wherein the predetermined data unit is located in the center of the region of interest.

42. An apparatus that determines at least one reference data unit for predictive coding a current data unit from a plurality of data units scanned prior to the current data unit using a region of interest oriented scanning method that forms at least one ring of data units around the current data unit, comprising:
a previous data selector unit that selects at least one of the plurality of data units located adjacent to the current data unit and scanned prior to the current data unit; and
a reference data unit determination unit that determines at least one reference data unit from the at least one selected previously scanned data unit according to predictive coding features,
wherein the current data unit is predictive coded according to the determined at least one reference data unit using a predetermined method.

43. The apparatus that determines at least one reference data unit as claimed in claim 42, wherein the adjacent location of each of the at least one selected previously scanned data unit is located horizontal, vertical, or diagonal to the current data unit.

44. The apparatus that determines at least one reference data unit as claimed in claim 43, wherein the current data unit is predictive coded based on a motion vector predicted value of the current data unit determined by performing a statistical analysis of respective motion vector values for at least two of the previously scanned data units located adjacent to the current data unit.

45. The apparatus that determines at least one reference data unit as claimed in claim 43, wherein the data units surrounding the current data unit are scanned in a rotational direction such that the region of interest includes a plurality of connected concentric rings extending towards the perimeter of the region of interest and enclosing the current data unit.

46. The apparatus that determines at least one reference data unit as claimed in claim 44, wherein when the current data unit is a connecting data unit that connects a current concentric ring with a previous concentric ring, predictive coding is performed according to two previous data units located adjacent and scanned prior to current data unit

47. The apparatus that determines at least one reference data unit as claimed in claim 45, further comprising scanning the previous data units used for predictive coding using in a rotational direction about a predetermined data unit.

48. The apparatus that determines at least one reference data unit as claimed in claim 47, wherein the predetermined data unit is located in the center of the region of interest.
